(19) United States
(12) Patent Application Publication
(10) Pub. No.: US 2007/0286530 A1
(43) Pub. Date: Dec. 13, 2007

(54) DATA MANAGEMENT APPARATUS, DATA MANAGEMENT METHOD, AND STORAGE MEDIUM

(75) Inventors: Hidetoshi Asasaka, Sagamihara-shi (JP); Hironobu Kitabatake, Ohta-ku (JP); Takeshi Ooyama, Yokohama-shi (JP); Shuji Someya, Adachi-ku (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/755,154

(22) Filed: May 30, 2007

(30) Foreign Application Priority Data
Jun. 7, 2006 (JP) 2006-158633

(51) Int. Cl. G06K 9/54; G06K 9/46; H04N 1/60

(52) U.S. Cl. 382/305; 382/190; 358/1.9

(57) ABSTRACT

A data management apparatus stores first feature information extracted from first image data and output condition information corresponding to the first image data. The data management apparatus determines whether second feature information extracted from second image data matches the stored first feature information. In addition, the data management apparatus determines whether an output condition under which the first output unit outputs the second image data matches the output condition represented by the stored output condition information. The data management apparatus outputs information indicating that the second image data matches the first image data when it is determined that the second feature information matches the first feature information and it is determined that the output condition under which the second image data is output matches the output condition represented by the stored output condition information.

### BACKGROUND OF THE INVENTION

1. Field of the Invention

The present invention relates to a data management system, a data management apparatus, a data management method, and a storage medium for managing data using feature information extracted from image data.

2. Description of the Related Art

Various techniques have been proposed for managing data using feature information extracted from image data.

For example, feature information extracted from an image in a document to be registered as an original document is stored in an original document information assurance server, and feature information extracted from an image in a subsequently scanned document is compared with the stored feature information. In this matching operation, if the two pieces of feature information match, it can be assured that the image in the subsequently scanned document contains information identical to that of the image whose feature information is registered as that of an original document (refer to, for example, Japanese Patent Laid-Open No. 2004-246662).

However, the above-described technology has the following drawbacks. For example, in the technology described in Japanese Patent Laid-Open No. 2004-246662, if the feature information extracted from an image in the subsequently scanned document matches the prestored feature information of the original image, it is assured that the subsequently scanned document matches the original document. In such a case, to indicate that the scanned document matches the original document, information that assures that the scanned document matches the original document may be added to the scanned image and the document may be output for printing or displaying.

However, when the pieces of feature information match and it has been verified that the scanned document matches the original document and, subsequently, the document is displayed or printed, the document may be output under conditions different from those under which the original document was output. For example, if an image that has been verified to be that of an original image is a color image and the image is printed or displayed in a monochrome mode, the output image is visually different from the original one.

### SUMMARY OF THE INVENTION

Accordingly, embodiments of the present invention provide a data management system, a data management apparatus, a data management method, and a storage medium that perform precise data management by registering feature information extracted from image data and information about an output condition corresponding to the image data.

According to an embodiment of the present invention, a data management system includes an extraction unit, a first output unit, a storage unit, a first determination unit, a second determination unit, and a second output unit. The extraction unit is configured to extract feature information of image data on the basis of the image data. The first output unit is configured to output the image data. The storage unit is configured to store first feature information extracted from first image data by the extraction unit and output condition information corresponding to the first image data. The first determination unit is configured to determine whether second feature information extracted from second image data by the extraction unit matches the first feature information stored in the storage unit. The second determination unit is configured to determine whether an output condition under which the first output unit outputs the second image data matches the output condition represented by the output condition information stored in the storage unit. The second output unit is configured to output information indicating that the second image data matches the first image data when the first determination unit determines that the second feature information matches the first feature information and the second determination unit determines that the output condition under which the second image data is output matches the output condition represented by the output condition information.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principle of the invention.

FIG. 1 is a block diagram illustrating an exemplary configuration of a personal computer and a multifunction printer according to a first exemplary embodiment of the present invention.

FIG. 2 is a block diagram illustrating an exemplary configuration of an original document information assurance server according to the first exemplary embodiment of the present invention.

FIG. 3 illustrates an exemplary configuration of an original document information assurance system according to the first exemplary embodiment.

FIG. 4 is a schematic illustration of a print process according to the first exemplary embodiment.

FIG. 5 is an external view of the multifunction printer according to the first exemplary embodiment.

FIG. 6 is a schematic illustration of the operation of the original document information assurance system according to the first exemplary embodiment.

FIG. 7 is an external view of an operation unit of the multifunction printer according to the first exemplary embodiment.

FIG. 8 illustrates a detailed print condition according to the first exemplary embodiment.

FIG. 9 illustrates an example of a detailed print condition according to the first exemplary embodiment.

FIG. 10 illustrates an example of a feature information management table according to the first exemplary embodiment.

FIG. 11 illustrates an example of the print condition in detail according to the first exemplary embodiment.

FIG. 12 is a flow chart depicting the registration of the original document information according to the first exemplary embodiment.

FIG. 13 is a flow chart of verifying the authenticity of the document information according to the first exemplary embodiment.

FIG. 14 illustrates a screen displayed on the operation unit according to the first exemplary embodiment.

FIG. 15 illustrates an example of printout including the originality assurance information according to the first exemplary embodiment.

FIG. 16 illustrates detailed display condition according to a second exemplary embodiment of the present invention.

FIG. 17 is a schematic illustration of the operation of an original document information assurance system according to a third exemplary embodiment of the present invention.

FIG. 18 is a flow chart depicting the registration of the original document information according to the third exemplary embodiment.

FIG. 19 is a flow chart of verifying the authenticity of the document information according to the third exemplary embodiment.

### DESCRIPTION OF THE EMBODIMENTS

Exemplary embodiments of the present invention are described below with reference to the accompanying drawings.

### First Exemplary Embodiment

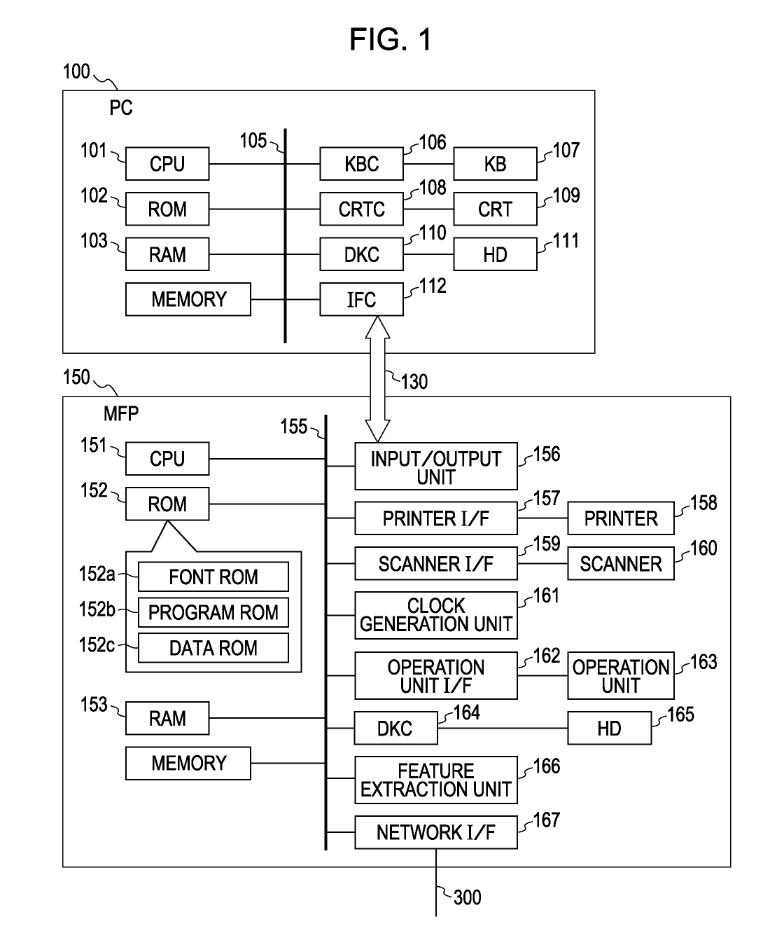

FIG. 1 is a block diagram illustrating an exemplary configuration of a personal computer (PC) 100 and a multifunction printer (MFP) 150 in an original document information assurance system according to a first exemplary embodiment of the present invention.

As shown in FIG. 1, the PC 100 includes a central processing unit (CPU) 101. The CPU 101 reads out a document processing program stored in a read only memory (ROM) 102 to process a document including a figure, an image, text, and a table. The CPU 101 further reads out and executes a program stored in the ROM 102 to perform overall control of units connected to a system bus 105. A random access memory (RAM) 103 functions as a main memory and a working area of the CPU 101. A keyboard controller (KBC) 106 controls key inputs from a keyboard (KB) 107.

A CRT controller (CRTC) 108 controls the output to be displayed on a CRT display (CRT) 109. A disk controller (DKC) 110 controls accesses to a hard disk (HD) 111 which stores a boot program, a variety of application programs, font data, and a variety of files. An interface controller (IFC) 112 controls a data communication process with the MFP 150 via a bidirectional interface 130.

The CPU 101 performs a decompression (rasterizing) process of an outline font so as to store the decompressed font in a display information RAM which is, for example, part of the random access memory (RAM) 103. Thus, the CPU 101 displays the preview of a printout on the CRT 109. In addition, the CPU 101 displays a variety of registered windows in response to a command selected using a mouse cursor on the CRT 109 so as to perform a variety of processes.

The MFP 150 includes a CPU 151. The CPU 151 reads out a control program stored in a program ROM 152b of a ROM 152 or a hard disk (HD) 165 to control units connected to a system bus 155. In addition, the CPU 151 performs control so as to output an image signal serving as print data to a printer 158 connected thereto via a printer interface (I/F) 157. Furthermore, the CPU 151 controls a scanner 160 connected thereto via a scanner interface (I/F) 159 so as to input scanned image data.

A font ROM 152a of the ROM 152 stores font data used for generating display data or print data. A data ROM 152c of the ROM 152 stores information referenced when the HD 165 serving as an external memory is not present. The CPU 151 can communicate with the PC 100 via an input/output unit 156 to send information about the printer 158 to the PC 100.

A RAM 153 is used for a main memory and a working area of the CPU 151. The RAM 153 functions as, for example, a receiving buffer, a page buffer, and a work buffer. By using a dedicated battery, the RAM 153 can hold information even when the MFP 150 is powered off.

A clock generation unit 161 generates an internal clock used for a process performed on the basis of time information among internal processes of the printer 158 or the scanner 160.

An operation unit 163 includes operation buttons and a liquid crystal panel unit 701. The operation buttons are used for operating the printer 158 and the scanner 160. The liquid crystal panel unit 701 is used for displaying an operation status.

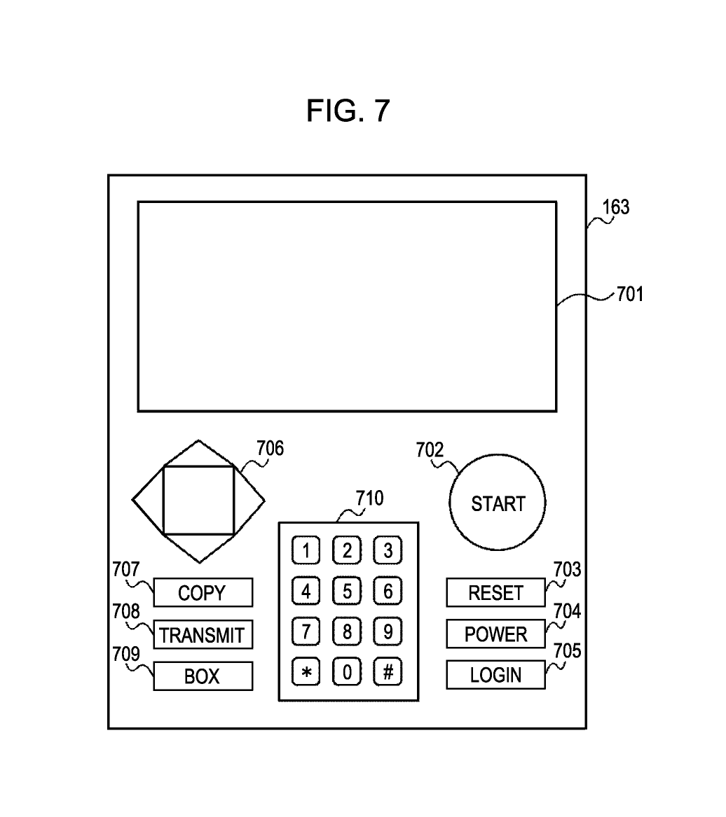

FIG. 7 is an external view of the operation unit 163 of the multifunction printer 150 according to an embodiment. The liquid crystal panel unit 701 displays the preview of a registered image and a unit status, such as a print status, or the results of a variety of processes. In addition, the liquid crystal panel unit 701 is a touch panel which detects the location at which a user touches so as to receive a variety of operational instructions and text information. A start button 702 is pressed when the user instructs start of a copy function or a transmission function.

In addition, the operation unit 163 includes hard keys, such as, a reset button for resetting the units, a power button for powering on or off the MFP 150, a ten key unit 710 for inputting, for example, a copy count, and a cursor key 706 for moving a cursor displayed on the liquid crystal panel unit 701. The operation unit 163 further includes mode keys for changing a function mode of the MFP 150. Examples of the mode key include a copy key 707, a transmit key 708, and a box key 709. A login key 705 is pressed for performing user authentication before a user operates the MFP 150. If the login key 705 is pressed while the user is logging in, the user can log out.

Referring back to FIG. 1, a disk controller (DKC) 164 controls accesses to a hard disk (HD) 165 that stores font data, a variety of files, and received data. A feature extraction unit 166 extracts feature information from print data received from the PC 100 or image data input from the scanner 160. Here, a suitable method for extracting feature information is employed (refer to, for example, Japanese Patent Laid-Open No. 2004-246662 as needed).

The extracted feature information is uniquely determined from information contained in the data (e.g., a character string and a figure). If the information is tampered with in any way, the feature information is changed. For the feature information, an error within the range caused by the readout precision of the scanner 160 may be negligible. In this way, a readout error occurring when a document is scanned is not mistakenly determined that it has been tampered with.

The feature extraction unit 166 can extract feature information from image data, such as bitmap image data. Alternatively, the feature extraction unit 166 can directly extract feature information from character code data without expanding into bitmap image data. As used herein, the term “image data” additionally refers to print data received from the PC 100, that is, a variety of types of data relating to an image, such as character code data or page description language (PDL) data before being expanded into bitmap image data.

A network interface (I/F) 167 is connected to a network 300 to which the MFP 150 and other apparatuses are connected, as described below. Thus, the network I/F 167 allows the MFP 150 to conduct data communication.

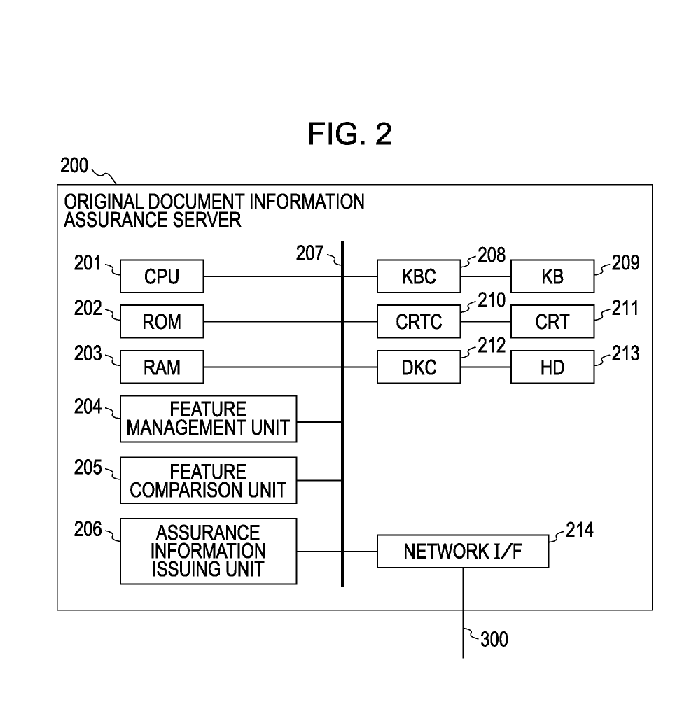

FIG. 2 is a block diagram illustrating an exemplary configuration of an original document information assurance server 200 according to the first exemplary embodiment of the present invention. A CPU 201 incorporated in the original document information assurance server 200 reads out and executes a program stored in a ROM 202 so as to perform overall control of devices connected to a system bus 207. A RAM 203 functions as a main memory and a working area of the CPU 201. A keyboard controller (KBC) 208 controls key inputs from a keyboard (KB) 209.

A CRT controller (CRTC) 210 controls the output to be displayed on a CRT display (CRT) 211. A disk controller (DKC) 212 controls accesses to a hard disk (HD) 213 which stores a boot program, a variety of application programs, font data, and a variety of files. The reliability of storing data on the hard disk (HD) 213 is increased by using a RAID-5 (redundant array of inexpensive disks-5) technique (a technique for increasing fault tolerance by storing data and parity information in a plurality of disk units). In addition, the hard disk (HD) 213 can prevent any unauthorized access. A network interface (I/F) 214 communicates with other data stations in the network 300 via the network 300.

A feature management unit 204 manages feature information of each of the image data items that are transmitted from the MFP 150 and are stored in the hard disk 213. As described below, in addition to the feature information of image data, the hard disk 213 stores information about an output condition associated with each of the image data items. A feature comparison unit 205 compares the feature information transmitted from, for example, the MFP 150 with the feature information stored in the hard disk 213. If the two pieces of feature information match, the CPU 201 determines that the image data from which the feature information is extracted contains the same information.

The operation of an assurance information issuing unit 206 starts if the feature comparison unit 205 determines that the two pieces of feature information match and the output condition of the image data matches the output condition represented by the output condition information stored in the hard disk 213. That is, the assurance information issuing unit 206 issues information assuring that the examined image data is identical to that of an original document and, subsequently, sends that information to a data station that sent the feature information (e.g., the MFP 150).

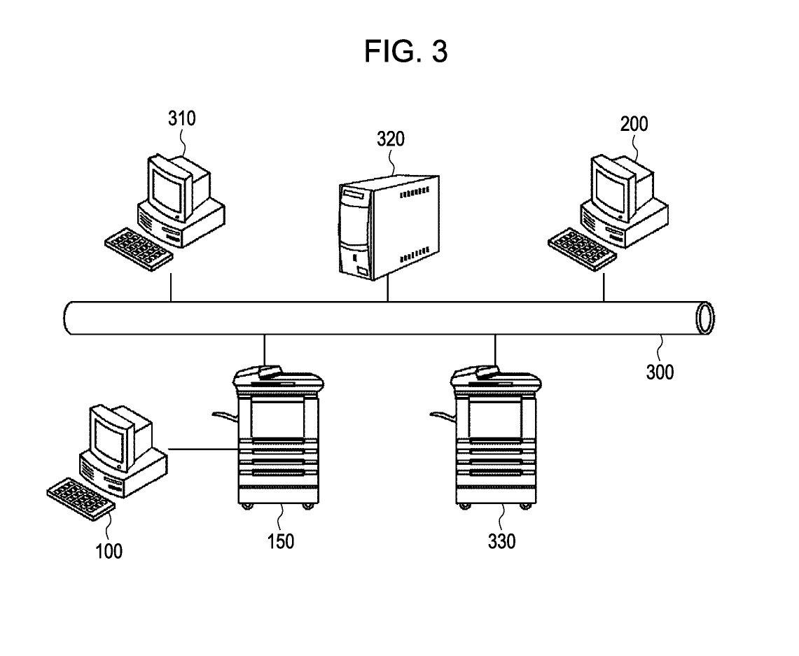

FIG. 3 illustrates an exemplary configuration of the original document information assurance system according to the first exemplary embodiment. The above-described PC 100 and MFP 150 are connected to each other via the bidirectional interface 130. In addition, the MFP 150 is connected to the original document information assurance server 200 via the network 300. The network 300 is a LAN or a WAN (the Internet). Furthermore, a mail server 320 for distributing electronic mails, a PC 310 having a function similar to that of the PC 100, and an MFP 330 having a function similar to that of the MFP 150 are connected to the network 300.

While the first exemplary embodiment has been described with reference to the MFP 150 that receives print data from the PC 100 via the bidirectional interface 130, the print data may be received using another method. For example, the MFP 150 may receive print data generated by the PC 310 connected thereto via the network 300. Alternatively, the MFP 150 may receive image data scanned by the MFP 330.

In addition, the original document information assurance system according to the first exemplary embodiment is configured from the PC 100 (or the PC 310), the MFP 150, and the original document information assurance server 200, as described below. However, the original document information assurance system may have a different configuration. For example, all the functions provided by these apparatuses may be included in one apparatus. Alternatively, required functions may be distributedly performed by additional apparatuses connected to the original document information assurance system via the network.

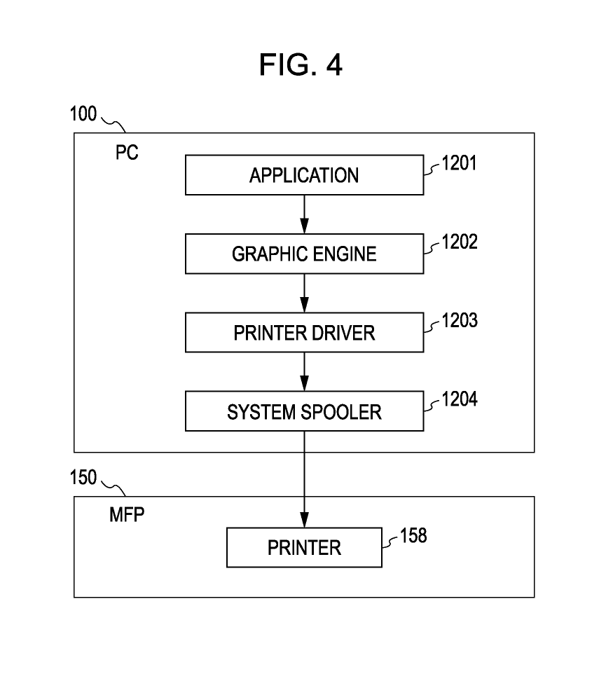

FIG. 4 illustrates a print process performed by the PC 100 and the printer 158 in the MFP 150. Programs, such as an application 1201, a graphic engine 1202, a printer driver 1203, and a system spooler 1204, are stored in the HD 111. When a print process is performed in response to an instruction from a user, these programs are loaded into the RAM 103 and are executed by an operating system (OS).

The application 1201 and the printer driver 1203 can be installed in the hard disk 111 by using a compact disc-read only memory (CD-ROM) or the network 300. When the application 1201 generates document/image data and prints the generated data using the printer 158, the application 1201 outputs (renders) the generated data through a graphic engine 1202. The graphic engine 1202 converts a graphic device interface (GDI) function output from the application 1201 to a device driver interface (DDI) function. The printer driver 1203 converts the DDI function output from the graphic engine 1202 to a printer control command, such as a page description language (PDL), which is recognizable by the printer 158. The converted page description language is output to the printer 158 via the system spooler 1204.

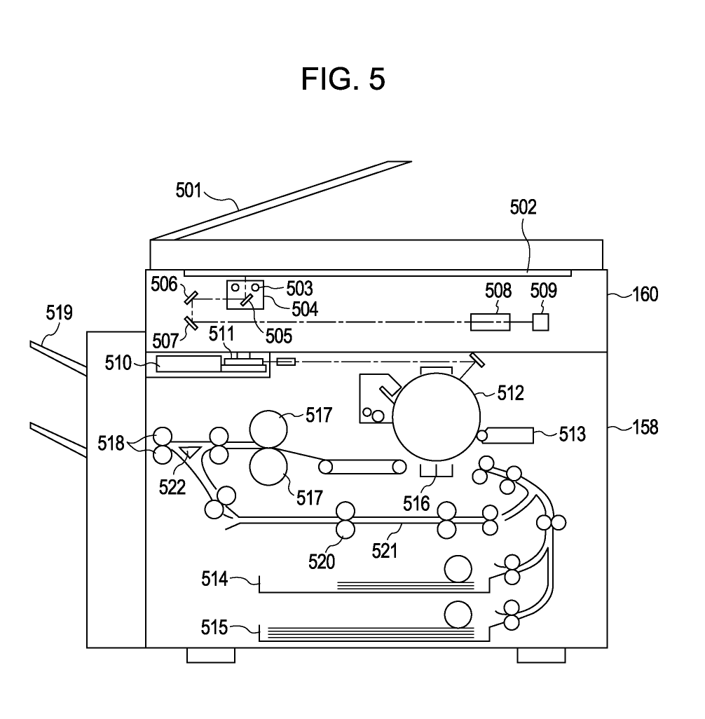

FIG. 5 is an external view of the MFP 150 according to an embodiment. As shown in FIG. 5, the scanner 160 is coupled with the printer 158. The scanner 160 includes a document feeder unit 501. The document feeder unit 501 feeds document sheets from the top of the sheets to a platen glass 502 one by one. Every time the scanning operation of the document sheet is completed, the document feeder unit 501 outputs the sheet from the platen glass 502 to an output tray.

When the sheet is delivered onto the platen glass 502, the scanner 160 illuminates a lamp 503 and starts to move a moving unit 504. By moving the moving unit 504, the scanning operation of the sheet disposed on the platen glass 502 is performed. During the scanning operation, light reflected off the sheet is led to a charge-coupled device (CCD) image sensor (hereinafter simply referred to as a “CCD”) 509 via mirrors 505, 506 and 507, and a lens 508. Thus, an image on the document sheet is formed on an imaging plane of the CCD 509. The CCD 509 converts the image formed on the imaging plane to an electrical signal and inputs the MFP 150.

The printer 158 includes a laser driver 510. The laser driver 510 drives a laser emitting unit 511 in accordance with the input image data. Thus, a laser beam is emitted from the laser emitting unit 511 in accordance with the image data. The laser beam is scanned onto a photoconductive drum 512.

An electrostatic latent image is formed on the photoconductive drum 512 by the emitted laser beam. The electrostatic latent image is visualized by means of toner supplied from a developing unit 513 in the form of a toner image. In synchronization with the emitting period of the laser beam, a paper sheet is delivered from one of cassettes 514 and 515 to a nip formed by the photoconductive drum 512 and a transfer unit 516 along a sheet conveying path. The toner image formed on the photoconductive drum 512 is transferred onto the fed paper sheet by the transfer unit 516.

The paper sheet having the toner image thereon is delivered to a fixing roller pair 517 consisting of a heat roller and a pressure roller by means of a transport belt. The fixing roller pair 517 hot presses the paper sheet, thereby fixing the toner image formed on the paper sheet onto the paper sheet. The paper sheet that has passed through the fixing roller pair 517 is output to a paper output unit 519 by an eject roller pair 518. The paper output unit 519 is composed of a sheet processing unit that can perform postprocessing, such as sorting and stapling.

In addition, when a duplex recording mode is set and the paper sheet is transported to the eject roller pair 518, the eject roller pair 518 is rotated in the opposite direction. Subsequently, the paper sheet is led to a refeeding roller 520 by a flapper 522. The paper sheet is then led to a refeeding path 521 and is refed to the nip formed by the photoconductive drum 512 and the transfer unit 516 during the above-described emitting period of the laser beam. Thus, a toner image is transferred onto the back side of the paper sheet.

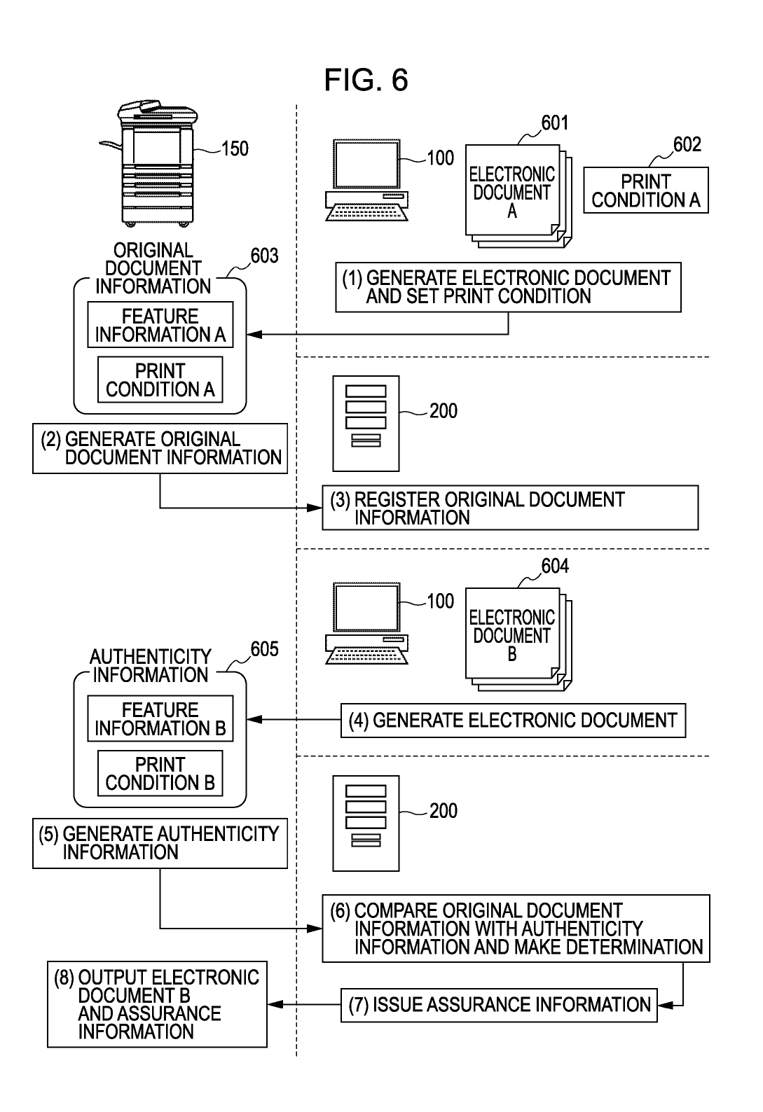

FIG. 6 is a schematic illustration of the operation of the original document information assurance system according to the first exemplary embodiment. In FIG. 6, processes performed by the MFP 150, the PC 100, and the original document information assurance server 200 are schematically illustrated. The left section of FIG. 6 illustrates the operation of the MFP 150 whereas the right section of FIG. 6 illustrates the operations of the PC 100 and the original document information assurance server 200. The MFP 150, the PC 100, and the original document information assurance server 200 communicate with each other via the network 300 or the bidirectional interface 130.

The PC 100 generates an electronic document-A 601 and sets a print condition-A 602. The PC 100 generates the electronic document-A 601 by using, for example, the above-described application. In addition, the PC 100 sets the print condition-A 602 using information input from a user through the keyboard 107. The print condition-A 602 is described in more detail later.

The generated electronic document-A 601 and the set print condition-A 602 are sent to the MFP 150. The feature extraction unit 166 of the MFP 150 extracts feature information A from the received electronic document-A 601. At that time, the feature extraction unit 166 may extract the feature information A from PDL data or bitmap image data obtained by expanding the PDL data. Subsequently, the feature information A extracted from the electronic document-A 601 and the print condition-A 602 are sent to the original document information assurance server 200 as original document information 603. The original document information assurance server 200 stores the received original document information 603 in the hard disk 213.

Thereafter, the PC 100 generates an electronic document-B 604 and sends the electronic document-B 604 to the MFP 150. As in the case of receiving the electronic document-A 601, the MFP 150 extracts feature information B from an electronic document B. Here, the electronic document B sent from the PC 100 is not necessarily the newly generated one. The electronic document A stored in advance may be read out and may be sent to the MFP 150 as the electronic document B.

In addition, the MFP 150 sets print conditions B. Here, the MFP 150 sets the print conditions B, for example, in accordance with the printing functionality information about the printer 158 included in the MFP 150. The printing functionality information is set by an administrator in advance or is provided by a manufacturer. Alternatively, the print conditions B may be set on the basis of print condition information that is input by the user as a print condition of the electronic document-B 604 and that is sent together with the electronic document-B 604.

Authenticity information 605 that includes the feature information B and the print conditions B is generated by the MFP 150 and is sent to the original document information assurance server 200. The feature comparison unit 205 of the original document information assurance server 200 compares the feature information A registered in advance and the sent feature information B. In addition, the CPU 201 determines whether the sent print conditions B match the print conditions A registered in advance.

Subsequently, on the basis of the comparison result from the feature comparison unit 205 and the determination result from the CPU 201, the assurance information issuing unit 206 issues assurance information and sends the assurance information to the MFP 150. This assurance information indicates that the content of the electronic document B is identical to that of the electronic document A and the electronic document B is output under the print conditions that meet those registered in advance so as to correspond to the electronic document A. The MFP 150 prints the electronic document B and the received assurance information.

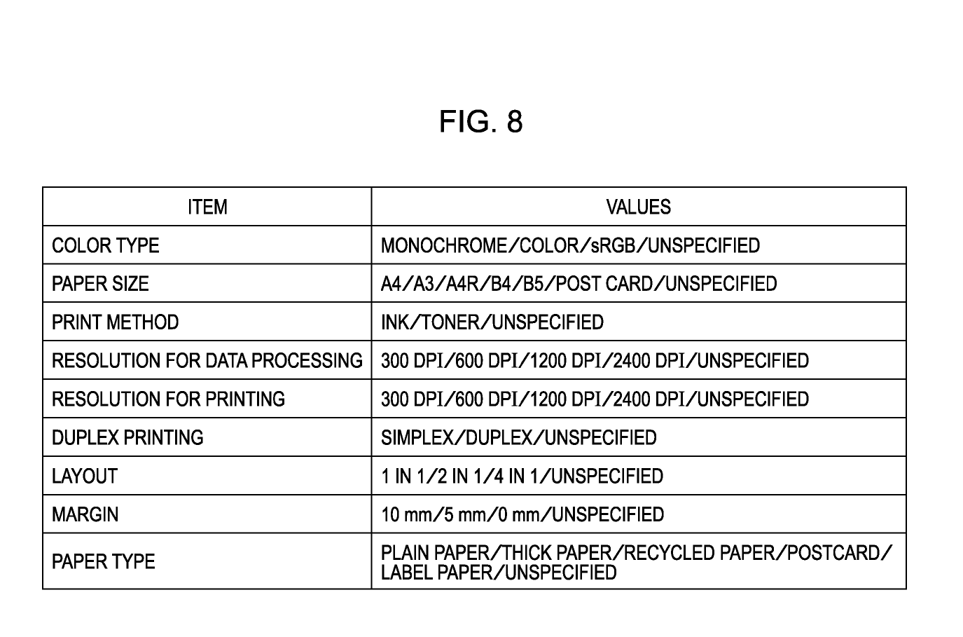

FIG. 8 illustrates the print conditions in detail according to the first exemplary embodiment. The print conditions include a color type, a paper size, a print method, a resolution for data processing, a resolution for printing, duplex printing, a layout, a margin, and a paper type. When original document information is registered, a user sets the desired condition items among the above-described condition items in order to maintain the legibility of the document. If “unspecified” is selected for each condition item, that condition item is not used for assuring the original document information.

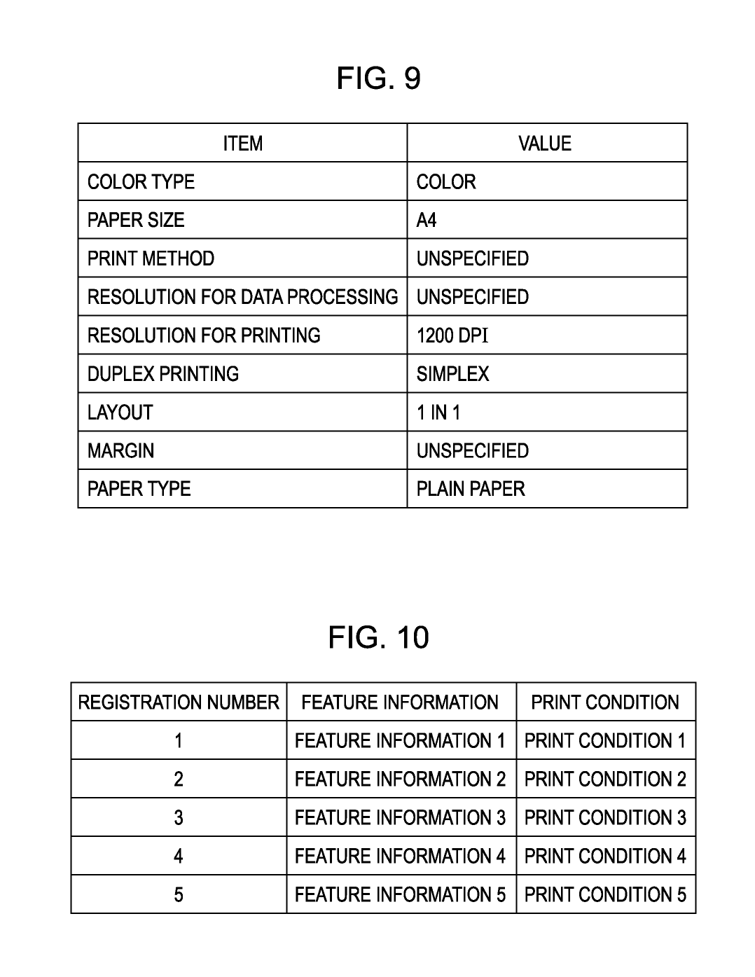

FIG. 9 illustrates an example of the print conditions-A 602 used in the original document information assurance system illustrated in FIG. 6. As shown in FIG. 9, the print conditions set for the electronic document-A 601 include, at least, color printing on an A4 plain paper sheet, a print resolution of 1200 dpi, simplex printing, and a layout of one page per sheet. The other condition items are specified as “unspecified”, and therefore, these condition items are not used for assuring the original document information. The print condition may further include other condition items in addition to the condition items illustrated in FIG. 9. Furthermore, in addition to specific values and methods as those shown in FIG. 9, the ranges of the values may be set (e.g., a resolution of 1200 dpi or more, and a paper size of A4 or B4).

In the original document information assurance server 200 shown in FIG. 2, the feature management unit 204 and the HD 213 perform registration of original document information. FIG. 10 illustrates an example of a feature information management table. The registered original document information has a registration number. When the original document information is registered, the feature information is associated with the print condition information. Although not shown in FIG. 6, after the original document information assurance server 200 has registered the original document information, the registration number of the original document information may be sent to the MFP 150 as registration information. In this way, when the MFP 150 sends the authenticity information 605 to the original document information assurance server 200, the registered original document information can be identified. Thus, the process can be simplified.

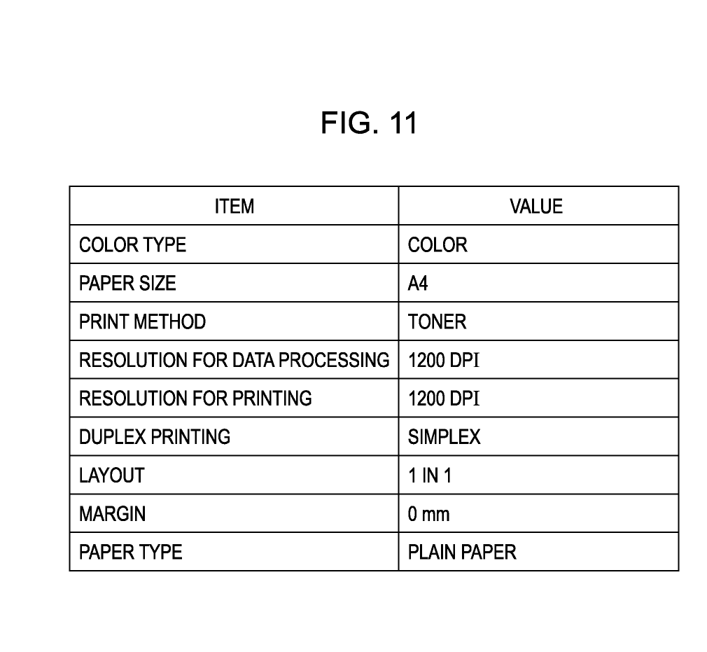

The setting operation of the print conditions B performed by the MFP 150 shown in FIG. 6 is described next. The print conditions B indicate the print conditions (parameters) used when the MFP 150 actually prints the electronic document-B 604. FIG. 11 illustrates examples of the print conditions B set by the MFP 150 in detail. The print method and the margin of the condition items contained in the print conditions B relate to the printing functionality of the MFP 150. The paper size and the duplex/simplex printing of the condition items contained in the print conditions B also relate to the printing functionality of the MFP 150. However, the user can set these condition items for the output. That is, when a printable paper size is, for example, only B4 or B5, the user cannot specify “A4” due to the printing functionality of the MFP 150. In contrast, even in the MFP 150 that can print a paper sheet of an A4 size, if the user specifies “B4”, the print condition item of “A4” is not set.

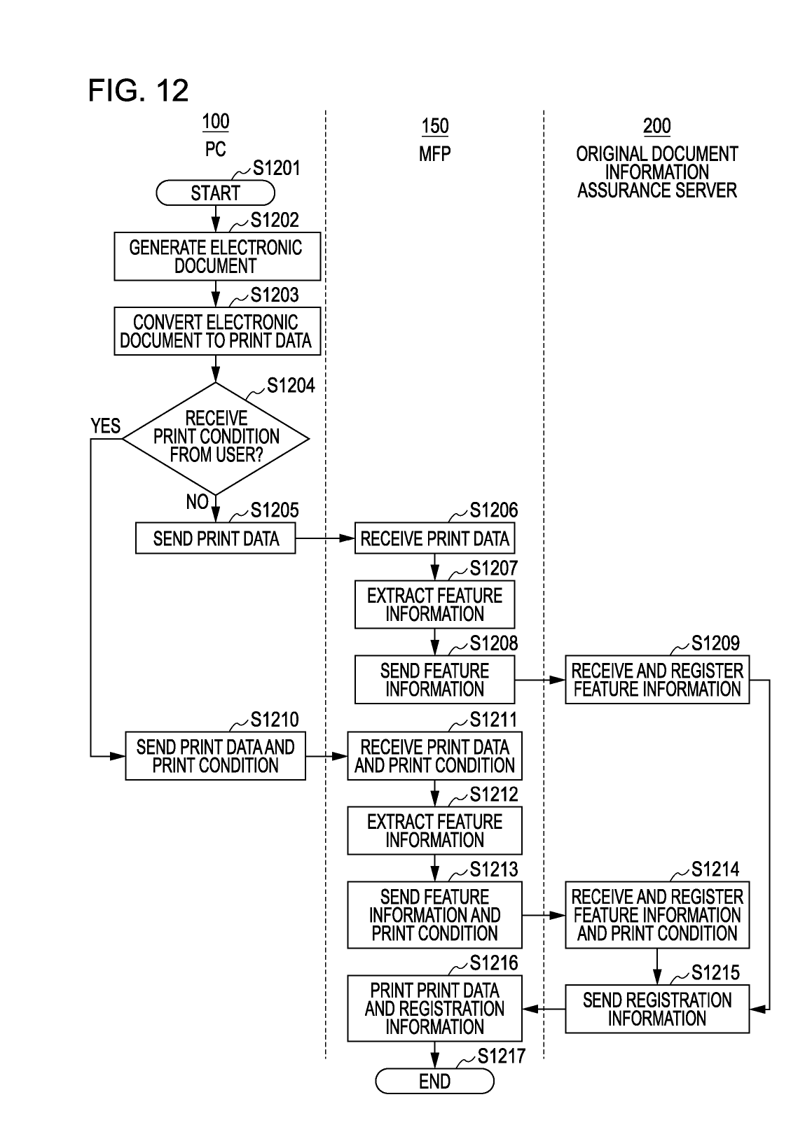

FIG. 12 is a flow chart depicting operations involved in the registration of original document information, which is the first half of the operation shown in FIG. 6, according to an embodiment. This operation of registration of the original document information is controlled by the CPUs 101, 151, and 201 of the PC 100, the MFP 150, and the original document information assurance server 200, respectively.

At step S1202, the application 1201 in the PC 100 generates an electronic document. Subsequently, at step S1203, the printer driver 1203 converts the generated electronic document to print data in order to print the electronic document. At step S1204, it is determined whether a user inputs a print condition.

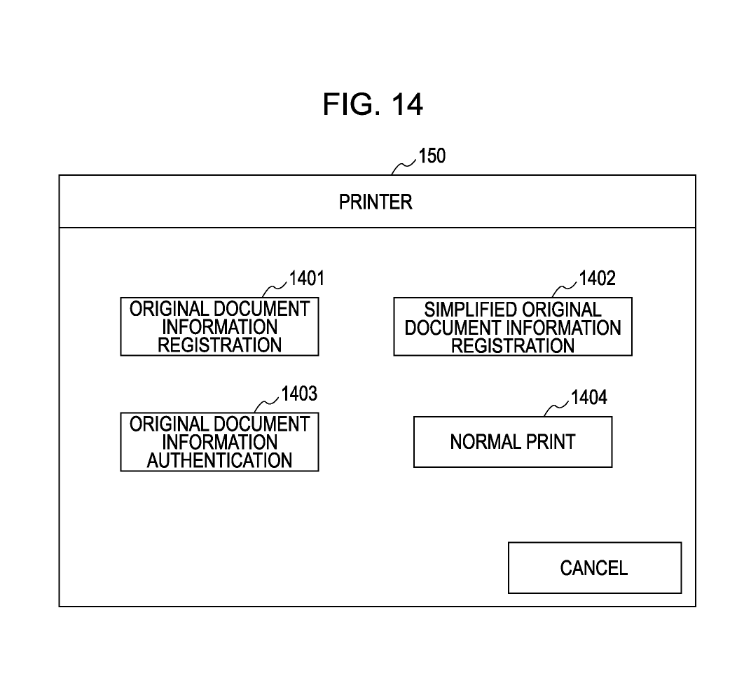

FIG. 14 illustrates a screen of the printer driver 1203 displayed on the CRT 109 when a variety of data in the PC 100 is printed. When an “original document information registration” button 1401 is selected, a subsequent screen is displayed. In the subsequent screen, the print condition including setting items shown in FIG. 9 is set. Thereafter, feature information about the original document and the print condition information are registered. If a “simplified original document information registration” button 1402 is selected, only the feature information extracted from the original document is registered without registering the print condition. If an “original document information authentication” button 1403 is selected, a process of matching the feature information and the print condition with the original document information registered in advance is performed, as described below. If a “normal print” button 1404 is selected, the MFP 150 prints only data without using the original document information assurance function.

As shown in FIG. 12, at step S1204, it is determined whether the “original document information registration” button 1401 or the “simplified original document information registration” button 1402 is selected in the screen shown in FIG. 14. If the “original document information registration” button 1401 is selected, the process proceeds to step S1210. At step S1210, the print data and the print condition information input by the user are sent to the MFP 150.

At step S1211, the MFP 150 receives the print data and the print condition information sent from the PC 100. Subsequently, at step S1212, the MFP 150 extracts feature information from the print data. At step S1213, the MFP 150 sends the extracted feature information and the print condition information to the original document information assurance server 200. The original document information assurance server 200, at step S1214, associates the received feature information with the received print condition information and registers the received feature information and print condition information.

However, if, at step S1204, the “simplified original document information registration” button 1402 is selected, the PC 100 does not receive the user input of the print condition and sends only the print data to the MFP 150 at step S1205. Then, at step S1206, the MFP 150 receives the print data from the PC 100. At step S1207, the MFP 150 extracts feature information from the print data received at step S1206. Thereafter, at step S1208, the MFP 150 sends the extracted feature information to the original document information assurance server 200. At step S1209, the original document information assurance server 200 registers the received feature information.

Upon registering the original document information at step S1209 or S1214, the original document information assurance server 200 generates registration information. The registration information contains a registration number shown in the feature information management table of FIG. 10, a user ID, and the registration date and time. At step S1215, the original document information assurance server 200 sends the generated registration information to the MFP 150. At step S1216, the MFP 150 prints the print data and the registration information. Thus, the process performed by the MFP 150 is completed.

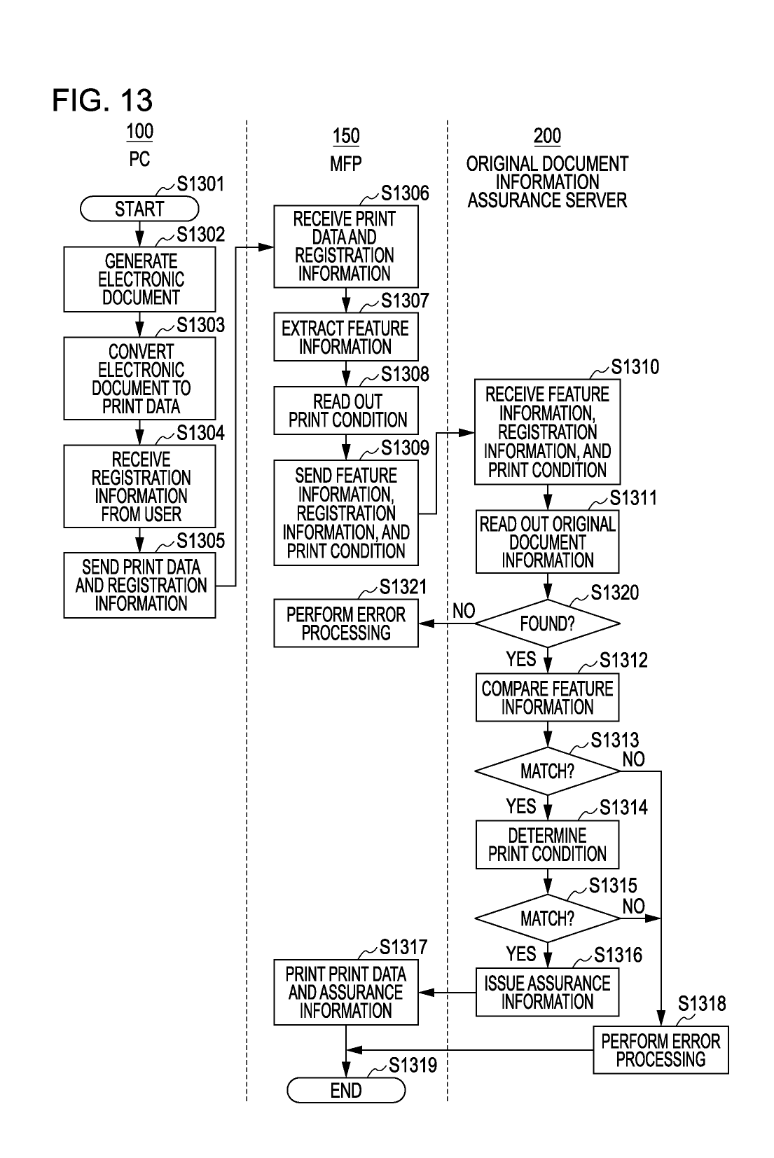

FIG. 13 is a flow chart of verifying the authenticity of document information, which is the second half of the operation shown in FIG. 6, according to an embodiment. This operation of verifying the authenticity of document information is controlled by the CPUs 101, 151, and 201 of the PC 100, the MFP 150, and the original document information assurance server 200, respectively.

At step S1302, the application 1201 in the PC 100 generates an electronic document. Subsequently, at step S1303, the printer driver 1203 converts the generated electronic document to print data in order to print the electronic document. As described earlier, at step S1302, the PC 100 does not necessarily generate a new electronic document, but may read out a document generated and stored in advance.

At step S1304, the PC 100 receives registration information that is used for identifying the original document information registered in the original document information assurance server 200 from the user. In an embodiment, the registration information is the information sent from the original document information assurance server 200 when the original document information is registered. If the original document information is not managed using the registration information, the need for this step can be eliminated. Subsequently, at step S1305, the PC 100 sends the print data and the registration information to the MFP 150.

At step S1306, the MFP 150 receives the print data and the registration information from the PC 100. At step S1307, the MFP 150 extracts feature information from the print data received at step S1306. Thereafter, at step S1308, the MFP 150 reads out the print condition. The readout print condition includes, for example, the condition items shown in FIG. 11. The print condition is determined by information originally set for the MFP 150 and the print settings determined by the user. At step S1309, the MFP 150 sends the feature information, the registration information, and the print condition information to the original document information assurance server 200. Then, at step S1310, the original document information assurance server 200 receives the feature information, the registration information, and the print condition information.

At step S1311, the original document information assurance server 200 reads out the original document information identified by the registration information received at step S1310. At step S1320, the original document information assurance server 200 determines whether it has found the feature information corresponding to the registration information. If the feature information is not present, the process proceeds to step S1321, where the original document information assurance server 200 sends an error message to the MFP 150. However, if, at step S1320, the original document information assurance server 200 is able to find the feature information corresponding to the registration information, the process proceeds to step S1312, where the feature comparison unit 205 compares the readout feature information with the received feature information.

Subsequently, at step S1313, it is determined whether the two pieces of feature information (i.e., the feature information corresponding to the registration information and the feature information extracted from the print data) match using the comparison result at step S1312. If the two pieces of feature information match, the process proceeds to step S1314, where the CPU 201 determines whether the received print conditions match the print conditions contained in the readout original document information. If, at step S1315, the print conditions are identical, the process proceeds to step S1316, where the assurance information issuing unit 206 issues assurance information and sends the assurance information to the MFP 150. At step S1317, the MFP 150 combines the print data with the assurance information and prints the print data. Here, after the assurance information is sent, the print conditions cannot be changed.

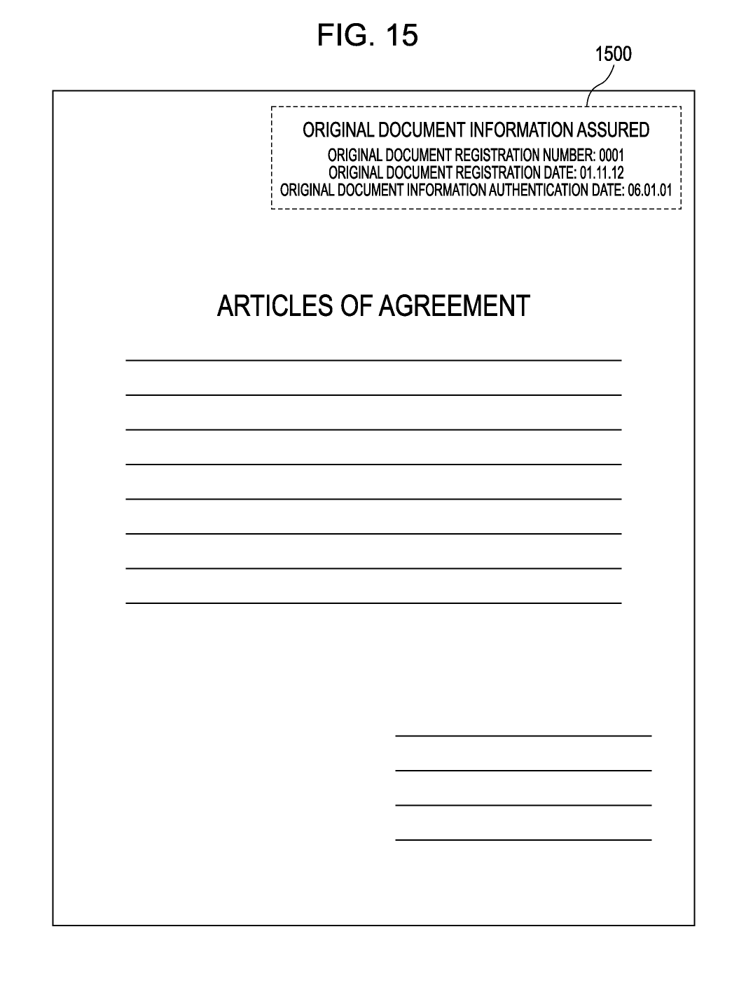

FIG. 15 illustrates an example of printout output at step S1317. As shown by a print area 1500, the printout includes printed assurance information at the upper right corner thereof. The printed assurance information indicates that the printout includes the same information as that in the registered original document. If the printed assurance information further indicates by which button “original document information registration” or “simplified original document information registration” the registered original document information has been registered, the ease of use can be further increased. Alternatively, instead of explicitly being printed as shown in FIG. 15, the assurance information may be embedded in the print data in the form of a watermark message that is hardly recognizable to the human eye using known copy-forgery-inhibition pattern technology. If the assurance information is attached to the print data and is printed using such a method, the attached assurance information is invisible to the human eye. However, if the printout is copied, it can be recognized that the copied printout is a replication. In contrast, if, at step S1313, the two pieces of feature information do not match or if, at step S1315, the print conditions do not match, the process proceeds to step S1318. At step S1318, error processing is performed so that a message indicating that the original document information cannot be assured is sent.

In this error processing, for example, a message indicating which setting item or setting items among the setting items of the output condition do not match is sent. For example, suppose the case where an error occurs when the print data of a B4 size is output although an A4 size is set for a paper size. In such a case, the message “A paper size that matches that of the original document has not been set” is displayed by the MFP 150 or the PC 100. This message indicates that the paper sizes do not match. At that time, if the message “The original document has an A4 size” is displayed, the user can change the print setting and perform the authentication process again. In this way, the ease of use can be further increased.

When the error processing is performed at step S1318, the printing process of the print data at step S1317 is skipped and the processing is completed. However, another method may be employed. For example, since the assurance information is not issued, the print operation may be performed without embedding the assurance information. That is, so-called “normal printing” may be performed.

As described above, according to the first exemplary embodiment, the print condition information is registered in the original document information assurance server 200 together with the feature information extracted from print data. Thereafter, the feature information extracted from a document when it is verified whether the document matches the original document is compared with the feature information registered in advance. At the same time, the print condition used for printing the document is compared with the print condition registered in advance. In this way, not only the fact that the information in the document is not tampered with can be assured by comparing the two pieces of feature information, but also the fact that the document has a print layout that is identical to that of the original document can be assured when the assured information is printed.

### Second Exemplary Embodiment

The second exemplary embodiment of the present invention is described next. Here, descriptions of the configurations similar to those in the first exemplary embodiment are not repeated. The second exemplary embodiment is different from the first exemplary embodiment in that the output condition of the first exemplary embodiment relates to printing, however, the output condition of the second exemplary embodiment relates to displaying.

The system configuration according to the second exemplary embodiment is similar to that shown in FIGS. 1 to 3 according to the first exemplary embodiment. In addition, the second exemplary embodiment operates in the similar manner as illustrated by the diagram depicting the operation of the original document information assurance system shown in FIG. 6. However, the term “print conditions” is replaced with “display conditions”.

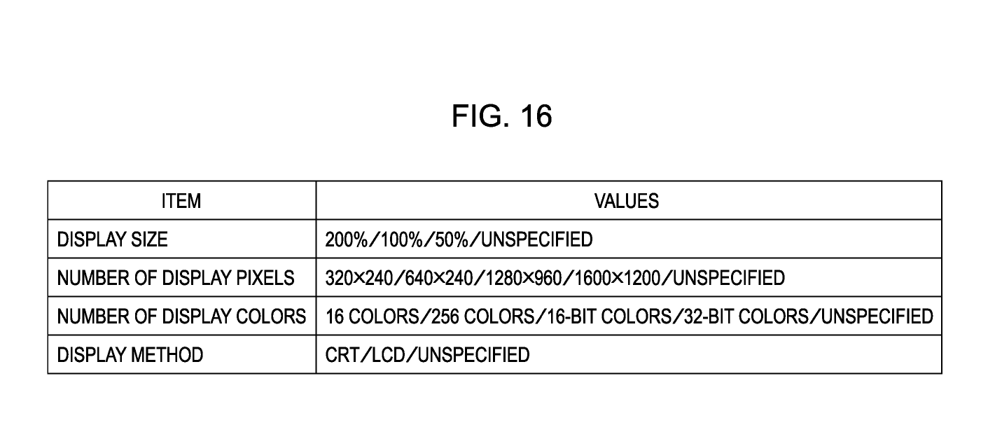

FIG. 16 illustrates detailed display conditions according to the second exemplary embodiment. As shown in FIG. 16, examples of the setting items of the display conditions include the display size of a display unit, the number of display pixels, the number of display colors, and a display method. A luminance, a contrast ratio, and a response speed (neither is shown) may be included in the display conditions.

Flow charts depicting the registration of the original document information and verifying of the authenticity of document information according to the second exemplary embodiment are similar to those shown in FIGS. 12 and 13 except for a few parts. Hereinafter, only differences between the first exemplary embodiment and the second exemplary embodiment are described.

As shown in FIG. 12, at step S1204, a user inputs display conditions as shown in FIG. 16 instead of the print conditions. At steps S1210 and S1211, the input display conditions are sent to the MFP 150. Subsequently, at steps S1213 and S1214, the display conditions are sent to the original document information assurance server 200. The original document information assurance server 200 associates the received feature information with the display conditions and registers the feature information and the display conditions.

A readout process of the display condition performed at step S1308 shown in FIG. 13 is described next. Here, the readout display condition indicates information about the display capability of the liquid crystal panel unit 701 of the MFP 150. The display capability of the liquid crystal panel unit 701 is set by an administrator in advance or set as default information by the manufacturer.

When data having assured original document information is displayed at a location different from the location of the liquid crystal panel unit 701 (e.g., on the CRT 109 of the PC 100), the display capability information about the target display unit is retrieved. Thereafter, at step S1314, the original document information assurance server 200 determines whether the received display condition meets the display condition information registered in advance.

When the original document information is assured, that is, when the assurance information is issued, the original document information assurance server 200 sends the assurance information to the MFP 150 or a unit that actually displays the assurance information. Thus, the data is displayed.

As described above, according to the second exemplary embodiment, the display condition information is registered in the original document information assurance server 200 together with the feature information extracted from data to be displayed. Thereafter, the feature information extracted from a document when it is verified whether the document matches the original document is compared with the feature information registered in advance. At the same time, the display condition used for displaying the document is compared with the display condition registered in advance. In this way, not only the fact that the information in the document is not tampered with can be assured by comparing the two pieces of feature information, but also the fact that the document has a display layout that is identical to that of the original document can be assured when the assured information is displayed. Since it is determined whether the two pieces of feature information match and whether the display conditions match the registered conditions, the authenticity of the document can be further accurately assured.

### Third Exemplary Embodiment

The third exemplary embodiment of the present invention is described next. Here, descriptions of the configurations similar to those in the first exemplary embodiment are not repeated. The third exemplary embodiment is different from the first and second exemplary embodiments in terms of a method of inputting original data from which feature information is extracted. That is, in the first and second exemplary embodiments, the feature information is extracted from print data sent from the PC 100. However, in the third exemplary embodiment, the feature information is extracted from image data scanned by the scanner 160.

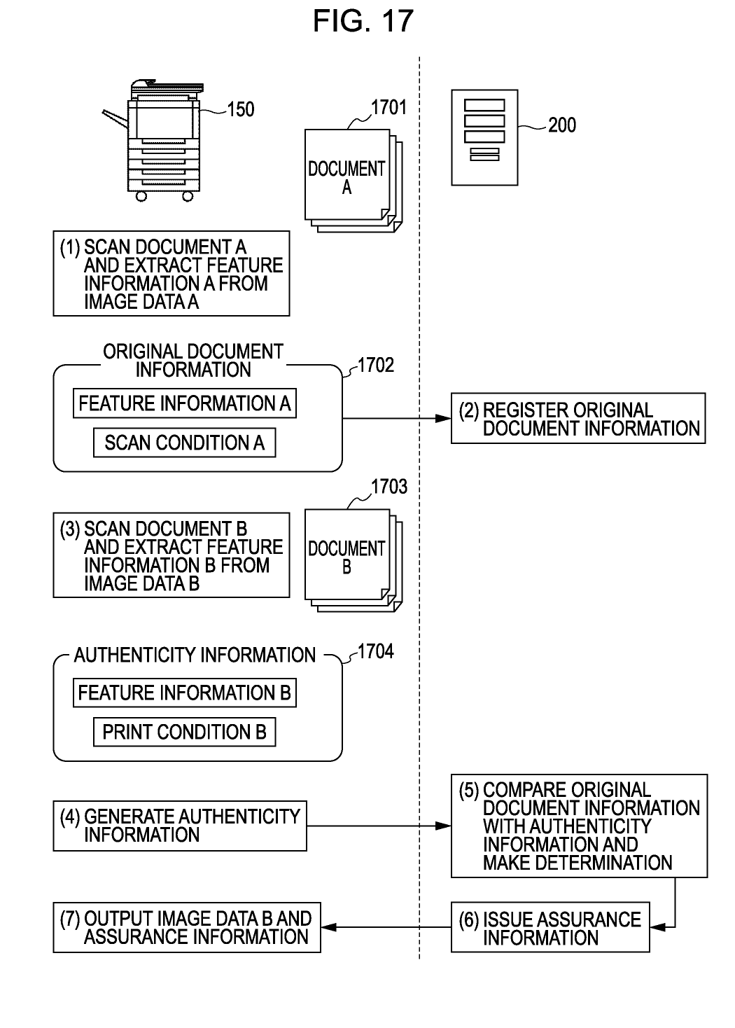

FIG. 17 is a schematic illustration of the operation of an original document information assurance system according to the third exemplary embodiment. In FIG. 17, processes performed by the MFP 150 and the original document information assurance server 200 are schematically illustrated. The left section of FIG. 17 illustrates the operation of the MFP 150 whereas the right section of FIG. 17 illustrates the operation of the original document information assurance server 200. The MFP 150 and the original document information assurance server 200 communicate with each other via the network 300.

A document A 1701 is scanned by the scanner 160 of the MFP 150. Thus, image data A is input. Subsequently, the feature extraction unit 166 extracts feature information A from the image data A. The feature extraction unit 166 sends original document information 1702 including the extracted feature information A and scan conditions under which the document A is scanned to the original document information assurance server 200. The original document information assurance server 200 registers the received original document information. The scan conditions are described in more detail below.

Thereafter, a document B 1703 is scanned by the scanner 160. Thus, image data B is input. Subsequently, as for the image data A, the feature extraction unit 166 extracts feature information B from the image data B. The feature extraction unit 166 generates authenticity information 1704 including the extracted feature information B and print conditions B and sends the authenticity information to the original document information assurance server 200.

The print conditions B are similar to the print conditions B according to the first embodiment. For example, the print conditions B are set on the basis of the printing functionality information about the printer 158 of the MFP 150. This printing functionality information is set by an administrator or the manufacturer in advance. Alternatively, the print conditions B may be set on the basis of print settings for printing the image data B input by the user when the document B is scanned.

The authenticity information 1704 that includes the feature information B and the print conditions B is generated by the MFP 150 and is sent to the original document information assurance server 200. The feature comparison unit 205 of the original document information assurance server 200 compares the feature information A stored in advance with the sent feature information B. In addition, the CPU 201 determines whether the sent print conditions B match the scan conditions A registered in advance.

Subsequently, on the basis of the comparison result from the feature comparison unit 205 and the determination result from the CPU 201, the assurance information issuing unit 206 issues assurance information and sends the assurance information to the MFP 150. This assurance information indicates that the content of the document B is identical to that of the document A and the document B is output under the print conditions that meet the scan conditions set when the document A is scanned. The MFP 150 displays or prints the document B and the received assurance information.

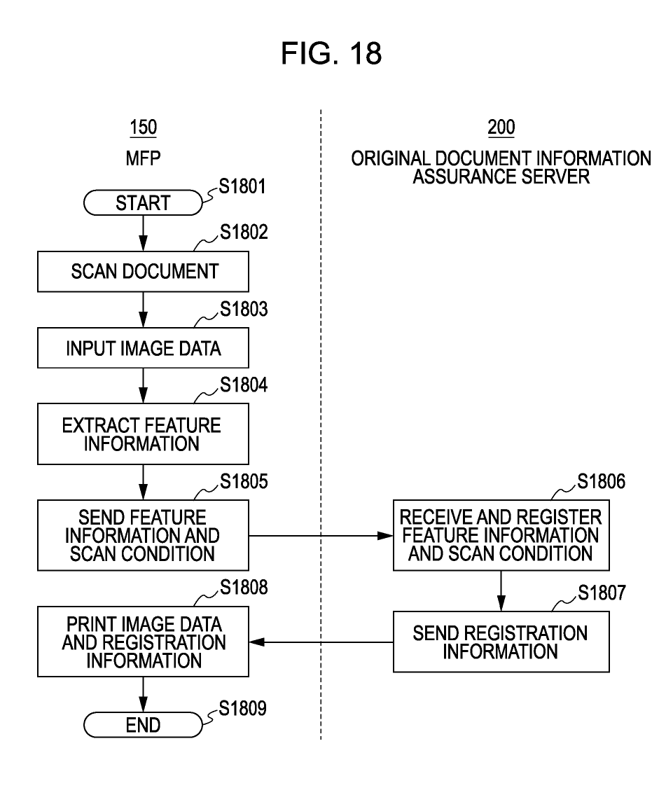

FIG. 18 is a flow chart depicting the registration of the original document information, which is the first half of the operation shown in FIG. 17. This operation of registration of the original document information is controlled by the CPUs 151 and 201 of the MFP 150 and the original document information assurance server 200, respectively.

At step S1802, an image in the document is scanned by the scanner 160. At step S1803, the scanned image is converted to image data and is input. At step S1804, feature information is extracted from the image data. At step S1805, the MFP 150 sends the extracted feature information and the scan conditions under which the document is scanned to the original document information assurance server 200.

The scan conditions indicate parameters associated with the document scan, such as color/monochrome scanning, a paper size, and simplex/duplex scanning. In general, a user who instructs the scan specifies the scan conditions. However, the MFP 150 may automatically determine the scan conditions in accordance with the state of the scanned document.

At step S1806, upon receipt of the feature information and the scan condition information, the original document information assurance server 200 associates the feature information with the scan condition information and stores the feature information and the scan condition information in the hard disk 213. The scan conditions are registered so as to serve as output condition information, which is compared with the output conditions under which the image data having assured original document information is output, as described below.

When the registration is completed at step S1806, the original document information assurance server 200 generates registration information and sends the registration information to the MFP 15 at step S1807. At step S1808, upon receipt of the registration information, the MFP 150 outputs and prints the image data and the registration information. Thus, the processing is completed.

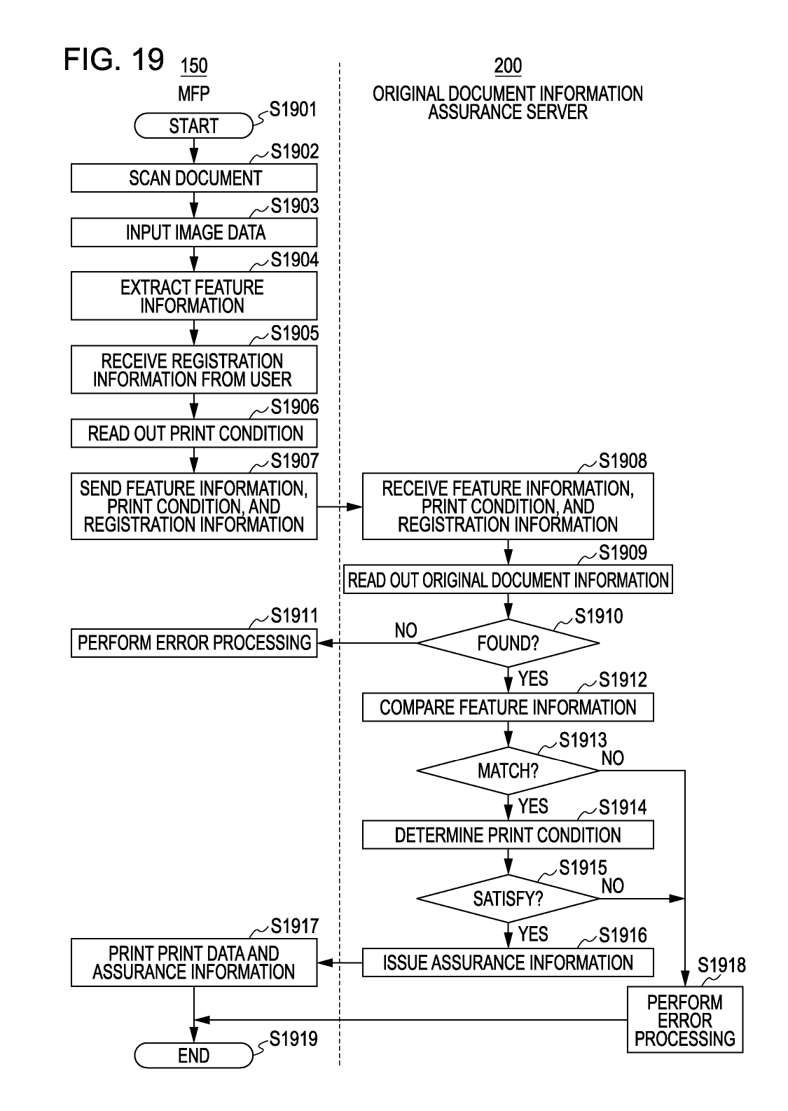

FIG. 19 is a flow chart of verifying the authenticity of document information, which is the second half of the operation shown in FIG. 17, according to an embodiment. This operation of verifying the authenticity of document information is controlled by the CPUs 151 and 201 of the MFP 150 and the original document information assurance server 200, respectively.

At step S1902, the MFP 150 scans an image in a document. At step S1903, the MFP 150 receives image data. Subsequently, at step S1904, the feature extraction unit 166 extracts feature information from the image data. At step S1905, the MFP 150 receives registration information input by a user. The user operates the operation unit 163 to input the registration information received at step S1807 shown in FIG. 18.

At step S1906, the MFP 150 reads out print conditions. These print conditions are determined on the basis of the parameters specified by the user as print settings for printing the image scanned at step S1902 or on the basis of the printing functionality information about the printer 158.

At step S1907, the MFP 150 sends the feature information, the print conditions, and the registration information to the original document information assurance server 200. At step S1908, the original document information assurance server 200 receives the feature information, the print conditions, and the registration information. At step S1909, the original document information assurance server 200 reads out the original document information corresponding to the registration information. At step S1910, the original document information assurance server 200 determines whether the feature information corresponding to the registration information is found. If the feature information is not found, the process proceeds to step S1911, where the original document information assurance server 200 sends an error message to the MFP 150. In contrast, if the feature information is found at step S1910, the process proceeds to step S1912, where the feature comparison unit 205 compares the readout feature information with the received feature information.

Subsequently, at step S1913, it is determined whether the two pieces of feature information match on the basis of the comparison result at step S1912. If the two pieces of feature information match, the process proceeds to step S1914. At step S1914, the CPU 201 determines whether the received print conditions meet the output condition (scan condition) information contained in the readout original document information. If, at step S1915, the received print conditions meet the readout output condition information, the process proceeds to step S1916. At step S1916, the assurance information issuing unit 206 issues assurance information to the MFP 150. At step S1917, the MFP 150 combines the image data with the assurance information and prints the image data having the assurance information. If, at step S1913, the two pieces of feature information do not match or, at step S1915, the received print conditions do not meet the readout output condition information, the process proceeds to step S1918, and performs error processing similar to the process of step S1318 in FIG. 13.

As described above, according to the third exemplary embodiment, the scan condition information can be registered in the original document information assurance server 200 together with the feature information extracted from image data scanned and input by the scanner 160. Thus, when it is verified whether the document matches the original document, the two pieces of feature information are compared. At the same time, it is determined whether the print conditions match the registered conditions. Accordingly, the authenticity of the document can be further accurately assured.

While the present invention has been described with reference to the first to third exemplary embodiments, the present invention is applicable to another method. For example, while the print conditions and the display conditions have been employed in the first and second embodiments, respectively, the combination of the print conditions and the display conditions may be employed as the output conditions. Alternatively, conditions different from these conditions may be employed and may be set.

### Other Exemplary Embodiments

While the present invention has been described in detail with reference to the exemplary embodiments, the present invention can be realized in the form of a system, an apparatus, a method, a program, and a storage medium (a recording medium). More specifically, the present invention can be applied to a system constituted by a plurality of devices, or to an apparatus comprising a single device.

The present invention can also be achieved by supplying a software program that realizes the function of the above-described exemplary embodiments (a program corresponding to flow charts in the accompanying drawings in the above-described exemplary embodiments) to a system or an apparatus directly or remotely and by causing a computer of the system or apparatus to read out and execute the software program code.

Accordingly, the program code itself installed in the computer to realize the functional processes of the present invention also realizes the present invention. That is, the present invention encompasses the computer program for realizing the functional processes of the present invention.

In such a case, the format of the program code may be any format. For example, the formats of the program code include object code, program code executed by an interpreter, and a script data supplied to an OS.

Examples of the recording medium for supplying the program code include a flexible disk, a hard disk, an optical disk, an MO (magneto optical) disk, a CD-ROM (compact disk-read only memory), a CD-R (CD recordable), a CD-RW (CD-rewritable), a magnetic tape, a nonvolatile memory card, a ROM, a DVD (digital versatile disc) (i.e., a DVD-ROM (DVD-read only memory) and a DVD-R (DVD recordable)) or the like.

In addition, the program may be supplied by accessing a home page on the Internet using a browser in a client computer and downloading the computer program of the present invention or an archive file including an auto-install function from the home page to a recording medium, such as a hard disk. Furthermore, program code of the program of the present invention may be divided into a plurality of files, which may be downloaded from different home pages. In other words, a WWW (world wide web) server that allows a plurality of users to download a program file that achieves the functions of the present invention are also included in the present invention.

Additionally, the program according to the present invention can be encrypted and stored into a recoding medium, such as a CD-ROM, to deliver it to users. A user who satisfies a predetermined criterion can download key information for decrypting the encryption from a home page on the Internet. By using the key information, the user can install the encrypted program in a computer and can execute the program to achieve the present invention.

Additionally, the functions of the above-described embodiments can be realized by another method in addition to executing the program code read out by the computer. For example, the functions of the above-described embodiments can be realized by a process in which an operating system (OS) running on the computer executes some of or all of the functions in the above-described embodiments under the control of the program code.

Furthermore, the functions of the above-described embodiments can be achieved by a process in which, after a program read from a recording medium is stored in a memory of an add-on expansion board inserted in a computer or a memory of an add-on expansion unit connected to a computer, a CPU in the add-on expansion board or in the add-on expansion unit executes some of or all of the functions in the above-described embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-158633 filed Jun. 7, 2006, which is hereby incorporated by reference herein in its entirety.

What is claimed is:

1. A system comprising:
an extraction unit configured to extract feature information of image data based on the image data;
a first output unit configured to output the image data;
a storage unit configured to store first feature information extracted from first image data by the extraction unit and output condition information corresponding to the first image data;
a first determination unit configured to determine whether second feature information extracted from second image data by the extraction unit matches the first feature information stored in the storage unit;
a second determination unit configured to determine whether an output condition under which the first output unit outputs the second image data matches the output condition represented by the output condition information stored in the storage unit; and
a second output unit configured to output information indicating that the second image data matches the first image data when the first determination unit determines that the second feature information matches the first feature information and the second determination unit determines that the output condition under which the second image data is output matches the output condition represented by the output condition information.

2. The system according to claim 1, further comprising:
a reading unit configured to read out an image in a document to receive image data of the image;
wherein the extraction unit extracts the feature information from the image data received by the reading unit.

3. The system according to claim 1, further comprising:
a communication unit configured to communicate with an external apparatus connected thereto via a network;
wherein the extraction unit extracts the feature information from the image data received from the external apparatus by the communication unit.

4. The system according to claim 2, further comprising:
a generating unit configured to generate the output condition information;
wherein the generating unit generates the output condition information based on a reading condition under which the reading unit reads out the image in the document to receive the image data.

5. The system according to claim 1, further comprising:
a generating unit configured to generate the output condition information;
wherein the generating unit generates the output condition information in accordance with an instruction from a user.

6. The system according to claim 1, wherein the first output unit includes a printing unit that prints the image data, and wherein the output condition information relates to a print condition of printing the first image data through the printing unit.

7. The system according to claim 6, wherein the output condition information includes at least one of a print paper size, resolution, and color or monochrome.

8. The system according to claim 1, wherein the first output unit includes a display unit that displays the image data, and wherein the output condition information relates to a display condition of displaying the first image data through the display unit.

9. The system according to claim 1, wherein the second determination unit determines whether the output condition set by a user when the first output unit outputs the second image data matches the output condition represented by the output condition information stored in the storage unit.

10. The system according to claim 1, further comprising:
a control unit configured to perform control so as to inhibit the output of the second image data from the first output unit if the first determination unit determines that the first feature information does not match the second feature information or if the second determination unit determines that the output condition of the second image data output from the first output unit does not match the output condition represented by the output condition information stored in the storage unit.

11. A method comprising:
storing first feature information extracted from first image data and output condition information corresponding to the first image data in a storage medium;
determining whether second feature information extracted from second image data matches the first feature information stored in the storage medium;
determining whether an output condition selected for outputting the second image data matches output condition represented by the output condition information corresponding to the first image data stored in the storage medium.

12. The method according to claim 11, wherein the output condition information corresponding to the first image data comprises information indicating a print condition selected for printing the first image data, and
wherein the output condition selected for outputting the second image data comprises a print condition selected for printing the second image data.

13. The method according to claim 11, further comprising:
outputting information indicating that the second image data matches the first image data when it is determined that the second feature information matches the first information and it is determined that the print condition selected for printing the second image data matches the print condition selected for printing the first image data.

14. A computer-readable storage medium storing a program that when executed by an apparatus causes the apparatus to execute operations comprising:
determining whether second feature information extracted from second image data matches first feature information extracted from first image data; and
determining whether an output condition corresponding to the second image data matches an output condition corresponding to the first image data.

15. The computer-readable storage medium according to claim 14, wherein the output condition corresponding to the second image comprises a print condition for printing the second image, and
wherein the output condition corresponding to the first image comprises a print condition for printing the first image.

16. The computer-readable storage medium according to claim 14, wherein the operations further comprises:
outputting information indicating that the second image data matches the first image data when it is determined that the second feature information matches the first feature information and it is determined that the output condition corresponding to the second image data matches the output condition corresponding to the first image data.

17. An apparatus comprising:
a storage unit to store first feature information extracted from first image data and output condition corresponding to the first image data; and
a processing unit configured to determine whether second feature information extracted from second image data matches the first feature information, the processing unit further configured to determine whether the output condition corresponding to the first image data matches an output condition corresponding to the second image data.

18. The apparatus according to claim 17, wherein the processing unit outputs information indicating that the second image data matches the first image data when it is determined that the second feature information matches the first feature information and it is determined that the output condition corresponding to the second image data matches the output condition corresponding to the first image data.

19. The apparatus according to claim 17, wherein the output condition corresponding to the first image data comprises a print condition selected for printing the first image data, and
wherein the output condition corresponding to the second image data comprises a print condition selected for printing the second image data.

20. The apparatus according to claim 17, wherein the output condition corresponding to the first image data indicates whether a color mode or a monochrome mode is selected for printing the first image data, and
wherein the output condition corresponding to the second image data indicates whether a color mode or a monochrome mode is selected for printing the second image data.

21. The apparatus according to claim 17, wherein the output condition corresponding to the first image data is associated with at least one of a print paper size, a resolution, and a layout selected for printing the first image data, and
wherein the output condition corresponding to the second image data is associated with at least one of a print paper size, a resolution, and a layout selected for printing the second image data.
